(19) United States
(12) Patent Application Publication
(10) Pub. No.: US 2017/0177225 A1
(43) Pub. Date: Jun. 22, 2017

(54) MID-LEVEL CONTROLLERS FOR PERFORMING FLASH MANAGEMENT ON SOLID STATE DRIVES

(71) Applicant: Nimble Storage, Inc., San Jose, CA (US)

(72) Inventor: Varun Mehta, San Jose, CA (US)

(21) Appl. No.: 14/977,272

(22) Filed: Dec. 21, 2015

(51) Int. Cl. G06F 3/06; G06F 12/02

(52) U.S. Cl. CPC G06F 3/0604; G06F 3/0652; G06F 3/0649; G06F 3/0688; G06F 12/0246; G06F 12/0253; G06F 2212/2022; G06F 2212/7211; G06F 2212/7205

(57) ABSTRACT

Described herein are techniques for interfacing a host device with a plurality of solid state drives (SSDs) via a plurality of mid-level controllers. The mid-level controllers comprise at least a first controller and a second controller. The first controller is communicatively coupled to a first group of the SSDs, and is configured to perform one or more flash management tasks for one or more SSDs within the first group of SSDs. The second controller is communicatively coupled to a second group of the SSDs, and is configured to perform one or more flash management tasks for one or more SSDs within the second group of SSDs.

### FIELD OF THE INVENTION

The present invention relates to methods and systems for performing flash management tasks on groups of solid state drives (SSDs), and more particularly, relates to offloading flash management tasks from a host device (and/or from SSDs) onto “mid-level” controllers which communicatively couple the host device to the SSDs.

### BACKGROUND

Most commercially available storage systems generally include those with disk drives (e.g., hard disk drives (HDDs)), those with solid-state drives (SSDs) (e.g., flash drives), and those with a combination of the two. Disk drives have the advantage of being lower cost than SSDs. On the other hand, it is typically faster to read data from an SSD than a disk drive. With the advancement of semiconductor technology, SSDs are becoming cheaper to manufacture. Accordingly, in storage systems with a combination of disk drives and SSDs, it is becoming increasingly advantageous to store a larger percentage of data using SSDs. Today, there are even “all-flash” storage systems, meaning that the storage systems only include SSDs.

In a storage system with a plurality of SSDs (and optionally HDDs), there typically is a controller within the storage system that interfaces the SSDs with devices outside of the storage system (e.g., devices such as client devices, servers, other storage systems, etc.). Such controller may be known as a host device. A host device may receive a request from a client device to access data stored on one or more SSDs within the storage system. In response, the host device may retrieve the data from one or more of the SSDs, and return the requested data to the client device. With an increasing number of SSDs, the host device is tasked with managing an increasing number of SSDs. Below, techniques are described to address the architectural challenge of interfacing the host device with an increasing number of SSDs, as well as techniques to allow the SSDs to operate more efficiently.

### SUMMARY OF THE INVENTION

In accordance with one embodiment, a plurality of “mid-level” controllers is included into a storage system to interface a host device of the storage system with a plurality of SSDs of the storage system. The mid-level controllers may include a first mid-level controller (hereinafter, “first controller”) and a second mid-level controller (hereinafter, “second controller”). The first controller may be communicatively coupled to a first group of the SSDs, and may be configured to perform one or more flash management tasks for one or more SSDs within the first group of SSDs. The second controller may be communicatively coupled to a second group of the SSDs, and may be configured to perform one or more flash management tasks for one or more SSDs within the second group of SSDs. The first group of the SSDs may be disjoint from the second group of the SSDs. In one embodiment, the mid-level controllers may be located in one or more components that are separate from the host device and separate from any of the SSDs. In other words, the mid-level controllers may not be part of the host device and may not be part of any of the SSDs.

In accordance with one embodiment, certain flash management tasks (e.g., deduplication, RAID operations, scrubbing, compression, garbage collection and encryption) may be delegated from the host device to the mid-level controllers. In other words, the host device may instruct a mid-level controller to perform a flash management task, and the mid-level controller is responsible for carrying out that flash management task. Such delegation of responsibility may be understood as a “downward” migration of intelligence (i.e., the direction of “downward” understood in the context of the components as illustratively arranged in FIG. 1). Such downward migration of intelligence makes the host device more available to handle other tasks (and makes the host device able to manage an increasing number of SSDs).

In accordance with one embodiment, certain flash management tasks (e.g., garbage collection, encryption, bad block management and wear leveling) may be managed by the mid-level controllers instead of and/or in addition to being managed locally within each SSD. There may be certain efficiencies that can be gained by this “upward” migration of intelligence (i.e., the direction of “upward” understood in the context of the components as illustratively arranged in FIG. 1). For example, the amount of processing required locally within each SSD to perform flash management tasks may be reduced and flash management decisions can be made with a more global perspective (i.e., a perspective across a group of SSDs). The “upward” migration of intelligence into the mid-level controllers has the added benefit in that it has little impact on the performance of the host device (as compared to the alternative scenario of migrating the intelligence of the SSDs into the host device). In the case that the mid-level of controllers perform flash management in addition to the flash management being performed locally within each SSD, it may be understood that the mid-level of controllers may oversee (e.g., direct) the flash management performed locally within each SSD.

In the description above, one may notice that certain flash management tasks (e.g., garbage collection, encryption) may be both migrated up and down. That is, certain management tasks (in a typical storage system) may be managed both globally at the host device and locally in each of the SSDs. In one embodiment, intelligence (e.g., system-level garbage collection) is migrated down from the host device into the mid-level controllers and intelligence (e.g., localized garbage collection) is migrated up from the SSDs into the mid-level controllers. The two pieces of intelligence may be unified into one piece of intelligence within the mid-level controllers.

These and other embodiments of the invention are more fully described in association with the drawings below.

### BRIEF DESCRIPTION OF THE DRAWINGS

FIG. 1 depicts a host device communicatively coupled to a first group of solid state drives (SSDs) via a first controller and the host device communicatively coupled to a second group of solid state drives (SSDs) via a second controller, in accordance with one embodiment.

FIG. 2 depicts a mapping between SSD identifiers and controller identifiers, in accordance with one embodiment.

FIG. 3 depicts a flow diagram for performing a first flash management task on a first group of SSDs, in accordance with one embodiment.

FIG. 4 depicts a flow diagram for performing a first flash management task on a first group of SSDs, in accordance with one embodiment.

FIG. 5 depicts a flow diagram for performing a first flash management task on a first group of SSDs and performing a second flash management task on a second group of SSDs, in accordance with one embodiment.

FIG. 6 depicts a flow diagram for performing a first flash management task on a first group of SSDs and performing a second flash management task on a second group of SSDs, in accordance with one embodiment.

FIG. 7 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Description associated with any one of the figures may be applied to a different figure containing like or similar components/steps. While the flow diagrams each present a series of steps in a certain order, the order of the steps may be changed.

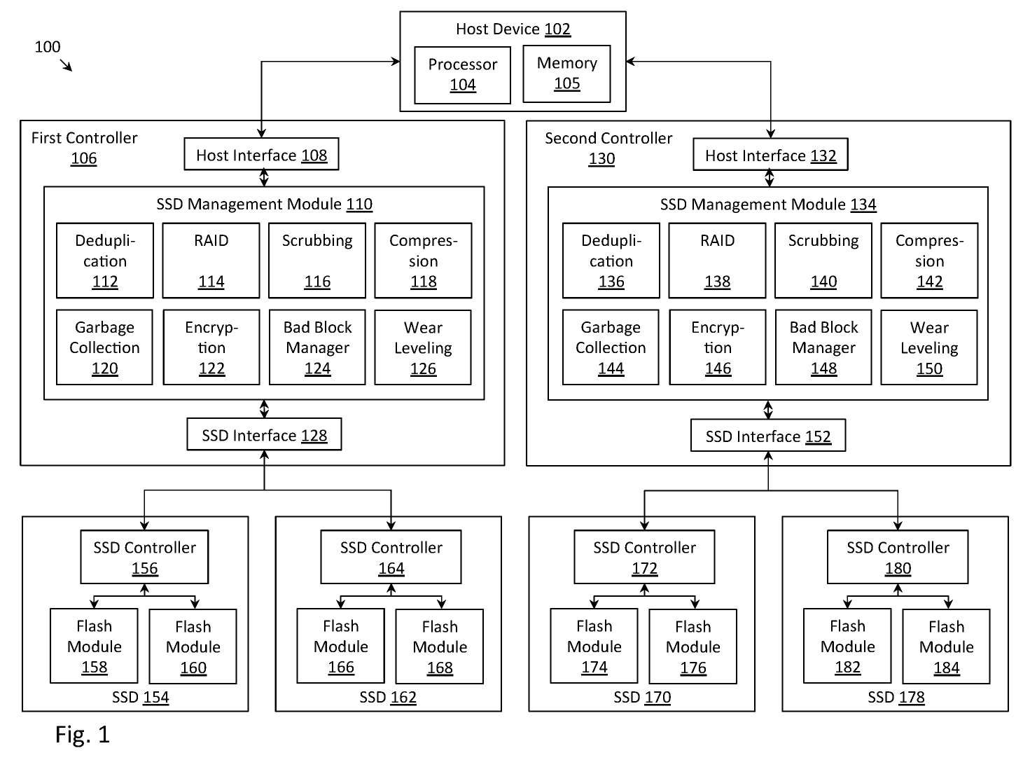

FIG. 1 depicts storage system 100 including host device 102 communicatively coupled to a first group of solid state drives (SSDs) (154, 162) via first controller 106 and host device 102 further communicatively coupled to a second group of solid state drives (SSDs) (170, 178) via a second controller 130, in accordance with one embodiment.

Host device 102 may comprise processor 104 (e.g., a central processing unit) and memory 105 (e.g., main memory). Memory 105 may store instructions which when executed by processor 104 cause processor 104 to perform one or more steps of a process. As mentioned above, host device 102 may interface storage system 100 with one or more client devices (not depicted). For example, host device 102 may receive a request for information from a client device, retrieve the requested information from SSD 154, and return the requested information to the client device.

First controller 106 may comprise host interface 108, SSD management module 110 and SSD interface 128. Host interface 108 may interface first controller 106 with host device 102, while SSD interface 128 may interface first controller 106 with SSDs 154 and 162. SSD management module 110 may perform various flash management tasks, including one or more of deduplication (performed by deduplication module 112), RAID (performed by RAID module 114), scrubbing (performed by scrubbing module 116), compression (performed by compression module 118), garbage collection (performed by garbage collection module 120), encryption (performed by encryption module 122), bad block management (performed by bad block manager module 124), wear leveling (performed by wear leveling module 126) and other flash management tasks (not depicted). In one embodiment, first controller 106 may be a port expander and/or implemented as a system-on-a-chip (SoC).

More details regarding general deduplication techniques may be found in Ki Jonghwa, et al. “Deduplication in SSDs: model and quantitative analysis”, IEEE 28th Symposium on Mass Storage Systems and Technologies, 2012, included herein by reference. More details regarding general RAID techniques may be found in Park, Kwanghee, et al. “Reliability and performance enhancement technique for SSD array storage system using RAID mechanism”, IEEE 9th International Symposium on Communications and Information Technology, 2009, included herein by reference. More details regarding general scrubbing techniques may be found in Wei, Michael Yung Chung, et al. “Reliably Erasing Data from Flash-Based Solid State Drives” FAST, Vol. 11, 2011, included herein by reference. More details regarding general compression techniques may be found in Zuck et al. “Compression and SSDs: Where and How?” 2nd Workshop on Interactions of NVM/Flash with Operating Systems and Workloads (INFLOW 14), 2014, included herein by reference. More details regarding garbage collection may be found in U.S. Pat. No. 8,285,918 to Umesh Maheshwari, included herein by reference. More details regarding general encryption techniques may be found in Jon Tanguy, “Self-Encrypting Drives”, Micron White Paper, 2013, included herein by reference. More details regarding general bad block management techniques may be found in “Bad Block Management in NAND Flash Memories”, STMicroelectronics Application Note, AN1819, 2004, included herein by reference. More details regarding general wear leveling techniques may be found in “Wear-Leveling Techniques in NAND Flash Devices”, Micron Technical Note, TN-29-42, 2008, included herein by reference.

Second controller 130 may comprise host interface 132, SSD management module 134 and SSD interface 152. Host interface 132 may interface second controller 130 with host device 102, while SSD interface 152 may interface second controller 130 with SSDs 170 and 178. SSD management module 134 may perform various flash management tasks, including one or more of deduplication (performed by deduplication module 136), RAID (performed by RAID module 138), scrubbing (performed by scrubbing module 140), compression (performed by compression module 142), garbage collection (performed by garbage collection module 144), encryption (performed by encryption module 146), bad block management (performed by bad block manager module 148), wear leveling (performed by wear leveling module 150) and other flash management tasks (not depicted). In one embodiment, second controller 130 may be a port expander and/or implemented as a system-on-a-chip (SoC).

SSD 154 may comprise SSD controller 156 and one or more flash modules (158, 160). SSD 162 may comprise SSD controller 164 and one or more flash modules (166, 168). SSD 170 may comprise SSD controller 172 and one or more flash modules (174, 176). SSD 178 may comprise SSD controller 180 and one or more flash modules (182, 184). In one embodiment, SSD 154, SSD 162, SSD 170 and SSD 178 may be off-the-shelf components.

In one embodiment, the host device 102 may be communicatively coupled to one or more of first controller 106 and second controller 130 via a serial attached SCSI (SAS) connection, an Ethernet connection and/or another type of connection. First controller 106 may be communicatively coupled to one or more of the SSDs (154, 162) via an SAS connection, an Ethernet connection and/or another type of connection. Likewise, second controller 130 may be communicatively coupled to one or more of the SSDs (170, 178) via an SAS connection, an Ethernet connection and/or another type of connection.

While the first group of SSDs is depicted with two SSDs, another number of SSDs may be present in the first group of SSDs. Likewise, while the second group of SSDs is depicted with two SSDs, another number of SSDs may be present in the second group of SSDs. While two groups of SSDs are communicatively coupled to host device 102 via two controllers, more groups of SSDs may be present in other embodiments. For example, eight groups of SSDs may be communicatively coupled to host device 102, with each group of SSDs communicatively coupled to host device 102 via a controller corresponding to each respective group of SSDs. Each group may include four SSDs, so the storage system may have a total of thirty-two SSDs.

While the embodiment of FIG. 1 depicts first controller 106 controlling a first group of SSDs (e.g., 154, 162), in other embodiments (not depicted) first controller 106 may control other types of storage devices (e.g., hard disk drives and optical disk drives) in addition or in the alternative to the first group of SSDs. Likewise, while the embodiment of FIG. 1 depicts second controller 130 controlling a second group of SSDs (e.g., 170, 178), in other embodiments (not depicted) second controller 130 may control other types of storage devices (e.g., hard disk drives and optical disk drives) in addition or in the alternative to the second group of SSDs.

In one embodiment, the first group of SSDs may be disjoint from the second group of SSDs (e.g., SSD 154 and SSD 162 being disjoint from SSD 170 and SSD 178). In another embodiment, the first group of SSDs may not be disjoint from the second group of SSDs (i.e., one SSD may belong to a plurality of groups).

In one embodiment, first controller 106 is not directly communicatively coupled to the second group of SSDs (i.e., SSD 170 and SSD 178). In other words, the only way for first controller 106 to communicate with the second group of SSDs is through second controller 130. In another embodiment (not depicted), first controller 106 may be directly communicatively coupled to one or more of the second group of SSDs (i.e., SSD 170 and SSD 178).

In one embodiment, second controller 130 is not directly communicatively coupled to the first group of SSDs (i.e., SSD 154, SSD 162). In other words, the only way for second controller 130 to communicate with the first group of SSDs is through first controller 106. In another embodiment (not depicted), second controller 130 may be directly communicatively coupled to one or more of the first group of SSDs (i.e., SSD 154 and SSD 162).

In one embodiment, host device 102 may determine one or more flash management tasks to perform on one or more target SSDs (e.g., SSDs within the first group). For example, host device 102 may desire to perform a garbage collection routine on SSD 154. In order to perform the one or more flash management tasks on one or more target SSDs, host device 102 may need to first determine a controller that controls the one or more target SSDs.

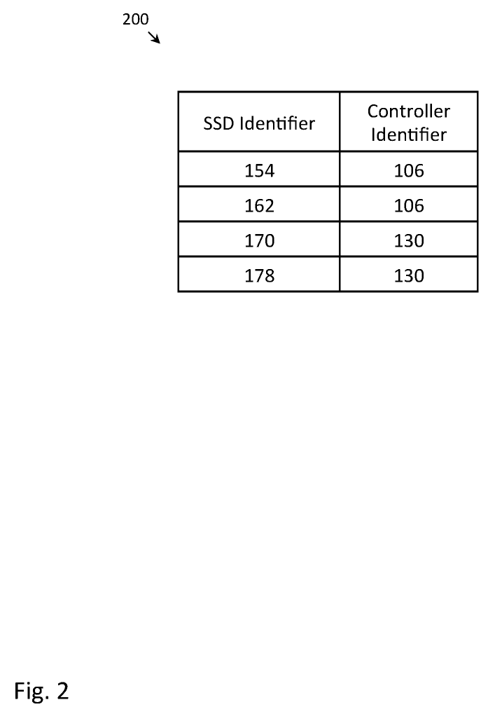

In one embodiment, host device 102 may access a mapping that maps an identifier of each SSD to an identifier of the controller that controls the SSD. Such mapping may be stored in memory 105 of host device 102. An example of such mapping is depicted in table 200 of FIG. 2. Table 200 depicts SSD 154 being mapped to first controller 106, SSD 162 being mapped to first controller 106, SSD 170 being mapped to second controller 130, and SSD 178 being mapped to second controller 130. (For ease of description, the reference numeral of each of the components has been used as the identifier of each of the components.)

In another embodiment, the above-described mapping may not be stored at host device 102 and/or may be stored at host 102 in an incomplete fashion (i.e., the mapping is known only for some SSDs). In such case, each controller may maintain a record of the SSDs that it controls. For example, first controller 106 may maintain a record that it controls SSD 154 and SSD 162; second controller 130 may maintain a record that it controls SSD 170 and SSD 178. Accordingly, host device 102 may send a query to each of the controllers to determine whether a particular SSD is controlled by the controller. For example, host device 102 may send a query to first controller 106, which inquires whether first controller 106 controls SSD 154, and in response to the query, first controller 106 may respond that it does control SSD 154. In contrast, host device 102 may send a query to second controller 130, which inquires whether second controller 130 controls SSD 154, and in response to the query, second controller 106 may respond that it does not control SSD 154.

Upon determining one or more of the controllers which controls the target SSDs, host device 102 may transmit a command to one or more of the controllers instructing the one or more controllers to perform one or more flash management tasks for the target SSDs. For example, host device 102 may transmit a command to first controller 106 instructing first controller 106 to perform a garbage collection task for SSD 154.

In response to receiving the command to perform one or more flash management tasks, a controller (e.g., 106 or 130) may perform the one or more flash management tasks for the one or more SSDs that it controls. Upon completing the one or more flash management tasks, the controller (e.g., 106 or 130) may inform host device 102 that the one or more flash management tasks have been completed.

Some motivations for the storage system architecture depicted in FIG. 1 are now provided. For ease of explanation, the SSDs (154, 162, 170 and 178) may be referred to as low-level components or being located at a low-level of storage system 100. First controller 106 and second controller 130 may be referred to as mid-level components or being located at a middle level of storage system 100. Host device 102 may be referred to as a high-level component or being located at a high-level of storage system 100. It is noted that adjectives such as low, mid, middle and high are used with respect to the visual arrangement of components in FIG. 1, and do not necessarily correspond to the physical placement of those components on, for example, a circuit board.

In one embodiment, flash management tasks (informally called “intelligence”) are migrated up from an SSD controller (e.g., 156, 164) into an SSD management module of a mid-level controller (e.g., 110). One reason for migrating the intelligence “up” (e.g., up from the low level to the middle level) is that each SSD only has a localized frame of reference of the data. Each SSD only manages the data that it stores, and does not manage the data located in other SSDs. If, however, some of the intelligence of an SSD were migrated upstream, flash management tasks could be performed more efficiently, because the flash management would be performed at a more system-wide level. One example of intelligence that may be migrated upwards is the flash translation layer (FTL) (or a part thereof), which manages garbage collection and maintains a record of obsolete and non-obsolete blocks (i.e., an obsolete block being a block that is no longer needed due to the creation of a newer version of that block).

In one embodiment, flash management tasks (informally called “intelligence”) are migrated down from processor 104 of host device 102 to a SSD management module (e.g., 110, 134). One reason for migrating the intelligence “down” is to allow the processing capabilities of host device 102 to be scaled more easily (and less expensively) as SSDs are added into system 100. Instead of upgrading the hardware of host device 102, mid-level controllers can be added in order to increase the processing capabilities of host device 102. Without suitable scaling of the processing capabilities of host device 102, host device 102 would quickly become a bottleneck to the flow of data as more SSDs are added.

The delegation of responsibilities might be a useful analogy to the downward migration of intelligence. By migrating the intelligence downwards, host device 102 may be delegating some of its responsibilities to the mid-level controllers. Rather than being responsible for the successful execution of a flash management task, host device 102 can instruct a mid-level controller (e.g., 106, 130) to perform a flash management task, which is then responsible for the successful execution of such flash management task. The system-wide perspective of the SSDs is not lost by the downward migration of intelligence, because host device 102 (which oversees the mid-level controllers) still has a system-wide perspective of the SSDs.

With respect to the flash management functionality depicted in FIG. 1, localized garbage collection, encryption, bad block management and wear leveling may be migrated up from the low level to the middle level to form (or form a portion of) garbage collection modules (120, 144), encryption modules (122, 146), bad block manager modules (124, 148) and wear leveling modules (126, 150), respectively. In contrast, deduplication, RAID calculations, scrubbing, compression, garbage collection and encryption may be migrated down from the high level to the middle level to form (or form a portion of) deduplication modules (112, 136), RAID modules (114, 138), scrubbing modules (116, 140), compression modules (118, 142), garbage collection modules (120, 144) and encryption modules (122, 146), respectively.

In a preferred embodiment, host device 102 may be highly available (HA), meaning that host device 102 includes an active and a standby controller. Further, host device 102 may store state information (e.g., the mapping from SSD identifiers to controller identifiers) in a non-volatile random access memory (NVRAM) located in host device 102. In contrast, the mid-level controllers (e.g., 106, 130) may not be highly available, meaning that a mid-level controller includes an active controller, but no standby controller. In the event that a mid-level controller fails, there may be a temporary loss of access to the SSDs managed by the failed mid-level controller until the mid-level controller is replaced and/or repaired. In further contrast to host device 102, the mid-level controller may not include an NVRAM. In the event that the mid-level controller fails (or loses power), certain state information (e.g., identifiers of the SSDs that the mid-level controller controls) may be lost and may need to be re-populated at the mid-level controller (e.g., state information may need to be sent from host device 102 to the mid-level controller). More specifically, a mid-level controller may be restarted with the assistance of host device 102.

In one embodiment, there are certain flash management tasks (e.g., garbage collection) that a mid-level controller can perform autonomously (i.e., need not be in response to an instruction from host device 102).

More context is now provided regarding system-level garbage collection versus localized garbage collection. Suppose a PowerPoint™ presentation with three slides were stored on system 100. To illustrate the concept of localized garbage collection, if the middle slide were modified in a flash-based file system, blocks at the end of a log may be allocated and used to store the modifications to the middle slide, while blocks storing the out dated portions of the middle slide are marked as unused and are subsequently freed by the localized garbage collection to store new information. Such processing may occur within one or more of the SSDs.

To illustrate the concept of system-level garbage collection, suppose the entire PowerPoint presentation were deleted by a user. There is a higher-level flag that contains a pointer to the entire PowerPoint presentation (e.g., flag within directory entry), and when the entire PowerPoint presentation is deleted by a user, host device 102 sets a flag (e.g., a flag present within an inode) to mark the file (containing the entire PowerPoint presentation) as deleted (without actually overwriting the PowerPoint presentation). While host device 102 is aware that the blocks corresponding to the entire PowerPoint presentation are free blocks, the SSDs are not made aware of this information. By integrating the system-level garbage collection with the localized garbage collection, the SSDs would be made aware that the blocks corresponding to the entire PowerPoint presentation are free blocks, providing the SSDs with a substantially greater number of free blocks to store data. As an example, suppose a PowerPoint presentation includes a total of six slides, with slides 1, 3 and 4 stored on SSD 154 and slides 2, 5 and 6 stored on SSD 170. Upon receiving the command to delete the presentation, host device 102 may instruct first controller 106 to delete slides 1, 3 and 4 (since those slides are present in the first group of SSDs) and may instruct second controller 130 to delete slides 2, 5 and 6 (since those slides are present in the second group of SSDs).

The discussion of a PowerPoint presentation was just one example to illustrate the scope of the system-level garbage collection versus the localized garbage collection. As another example, the system-level garbage collection may have access to data at the file level, whereas the localized garbage collection may have access to data at the page level. As yet another example, the system-level garbage collection may have access to data at the volume level, LUN (logical unit) level, directory level, file level, etc., whereas the localized garbage collection may not have access to data at these levels.

As another example, suppose a file includes a total of six blocks (e.g., stored in a linked-list), with blocks 1, 3 and 5 stored on SSD 154 and blocks 2, 4 and 6 stored on SSD 170. Upon receiving a command to delete the file (e.g., deletion flag set in i-node of file), host device 102 may send system level information to the first and second controllers (e.g., instruct first controller 106 to delete blocks 1, 3 and 5 and instruct second controller 130 to delete blocks 2, 4 and 6). Subsequently, first controller 106 may, in the case of a SCSI interface, send TRIM commands to SSD 154 to delete blocks 1, 3 and 5, and second controller 130 may similarly send TRIM commands to SSD 170 to delete blocks 2, 4 and 6.

While the system-level garbage collection may be migrated down and the localized garbage collection may be migrated up, there would be one unified garbage collection in each of the mid-level controllers in some embodiments.

Not only do flash management tasks need to be performed, but they also need to be scheduled. While the scheduling could be performed by a host device in a two-level architecture (i.e., architecture with host device directly coupled to SSDs), the scheduling responsibilities of the host device can quickly become unmanageable with an increasing number of SSDs. In the architecture of FIG. 1, scheduling tasks can be performed by the mid-level controllers, which frees the host device to perform other tasks.

In one embodiment, RAID must be reconfigured to account for new failure domains. In prior systems, the failure domains were individual SSDs, since each SSD fails independently of other SSDs. In the system of FIG. 1, first controller 106 and the first group of SSDs (i.e., SSD 154, SSD 162) is one failure domain, and second controller 130 and the second group of SSDs (i.e., SSD 170, SSD 178) is another failure domain. This reason for such failure domains is that the failure of first controller 106 (second controller 130) will cause the loss of access to all of the SSDs within the first (second) group, respectively. To accommodate for these new failure domains, RAID must be performed across these new failure domains. In other words, data may be encoded such that data from one failure domain can be used to recover data from another failure domain. In other words, data may be encoded such that data from SSDs 170 and 178 can be used to recover data that is lost or temporarily unavailable from SSDs 154 and 162.

Stated differently, storage system 100 should handle the scenario of one (or more) of the mid-level controllers failing. Therefore, RAID (or erasure coding) must be performed across the mid-level controllers to ensure that storage system 100 can survive the failure of one (or more) of the mid-level controllers.

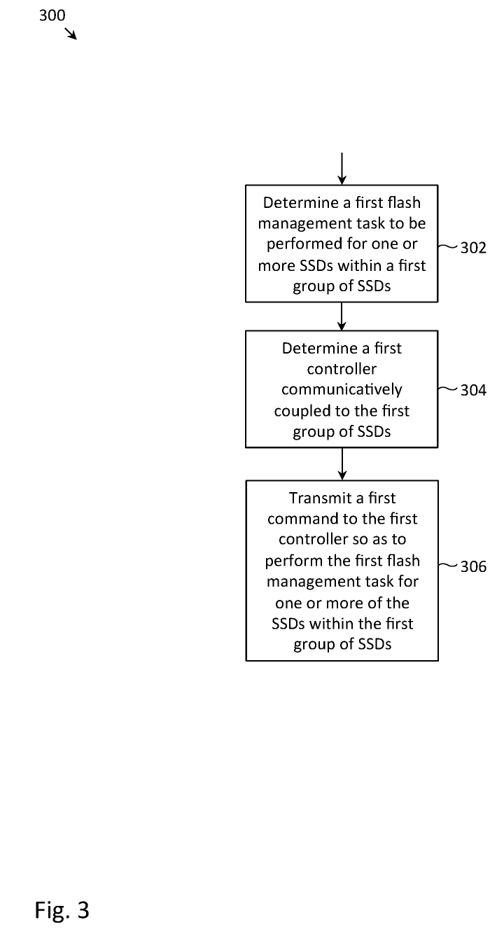

Flow diagrams are now presented to describe the processes performed in FIG. 1 in more detail. FIG. 3 depicts flow diagram 300 for performing a first flash management task on a first group of SSDs, in accordance with one embodiment. In step 302, host device 102 may determine a first flash management task to be performed for one or more SSDs within a first group of SSDs. At step 304, host device 102 may determine a first controller communicatively coupled to the first group of SSDs. At step 306, host device 102 may transmit a first command to the first controller so as to perform the first flash management task for one or more of the SSDs within the first group of SSDs.

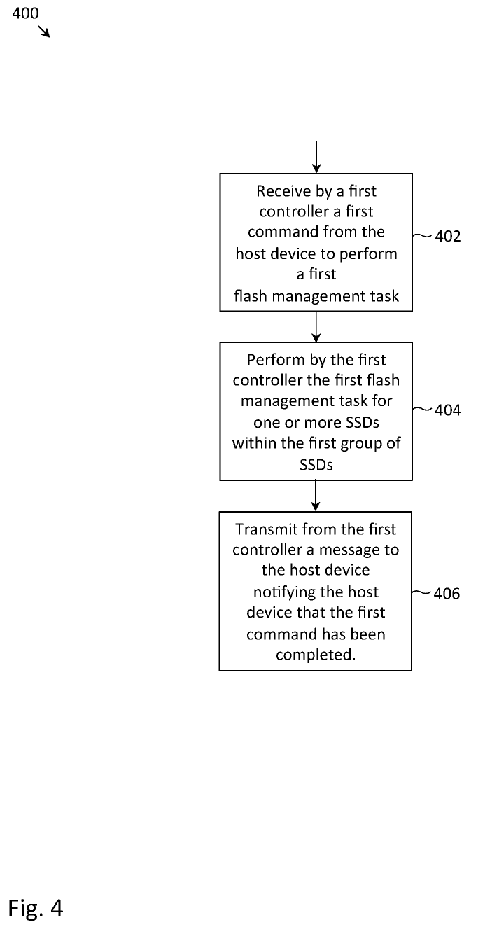

FIG. 4 depicts flow diagram 400 for performing a first flash management task on a first group of SSDs, in accordance with one embodiment. In step 402, first controller 106 may receive a first command from host device 102 to perform a first flash management task. At step 404, first controller 106 may perform the first flash management task for one or more SSDs within the first group of SSDs. At step 406, first controller 106 may transmit a message to host device 102 notifying host device 102 that the first command has been completed.

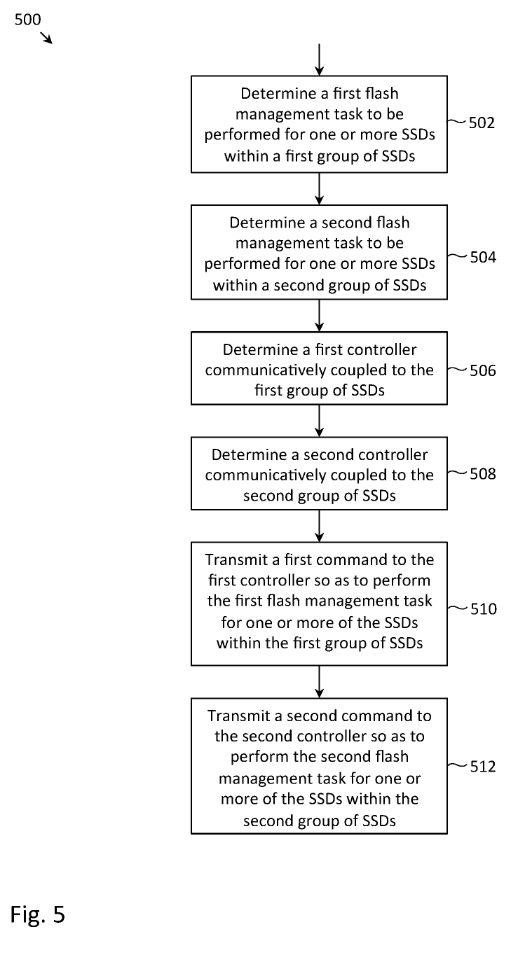

FIG. 5 depicts flow diagram 500 for performing a first flash management task on a first group of SSDs (e.g., 154, 162) and performing a second flash management task on a second group of SSDs (e.g., 170, 178), in accordance with one embodiment. At step 502, host device 102 may determine a first flash management task to be performed for one or more SSDs within a first group of SSDs. At step 504, host device 102 may determine a second flash management task to be performed for one or more SSDs within a second group of SSDs. The first flash management task may or may not be identical to the second flash management task. At step 506, host device 102 may determine a first controller (e.g., 106) communicatively coupled to the first group of SSDs (e.g., 154, 162). At step 508, host device 102 may determine a second controller (e.g., 130) communicatively coupled to the second group of SSDs (e.g., 170, 178). At step 510, host device 102 may transmit a first command to the first controller so as to perform the first flash management task for one or more of the SSDs within the first group of SSDs. At step 512, host device 102 may transmit a second command to the second controller so as to perform the second flash management task for one or more of the SSDs within the second group of SSDs.

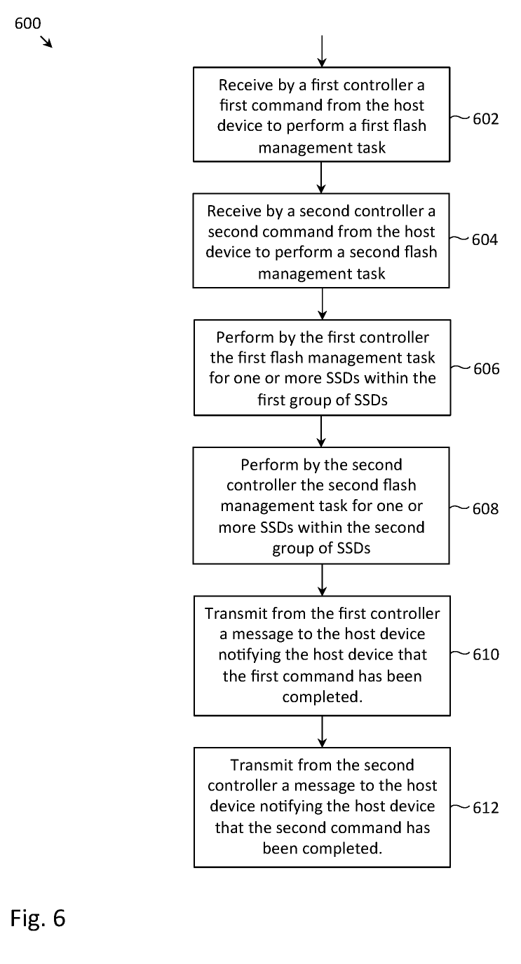

FIG. 6 depicts flow diagram 600 for performing a first flash management task on a first group of SSDs (e.g., 154, 162) and performing a second flash management task on a second group of SSDs (e.g., 170, 178), in accordance with one embodiment. At step 602, first controller 106 may receive a first command from host device 102 to perform a first flash management task. At step 604, second controller 130 may receive a second command from host device 102 to perform a second flash management task. At step 606, first controller 106 may perform the first flash management task for one or more SSDs within the first group of SSDs. At step 608, second controller 130 may perform the second flash management task for one or more SSDs within the second group of SSDs. At step 610, first controller 106 may transmit a message to host device 102 notifying host device 102 that the first command has been completed. At step 612, second controller 130 may transmit a message to host device 102 notifying the host device that the second command has been completed. It is noted that the order of the steps may be varied. For example, steps 602, 606 and 610 may be performed by first controller 106, followed by steps 604, 608 and 612 being performed by second controller 130. As another possibility, steps 602 and 604 may be performed concurrently, steps 606 and 608 may be performed concurrently, and steps 610 and 612 may be performed concurrently.

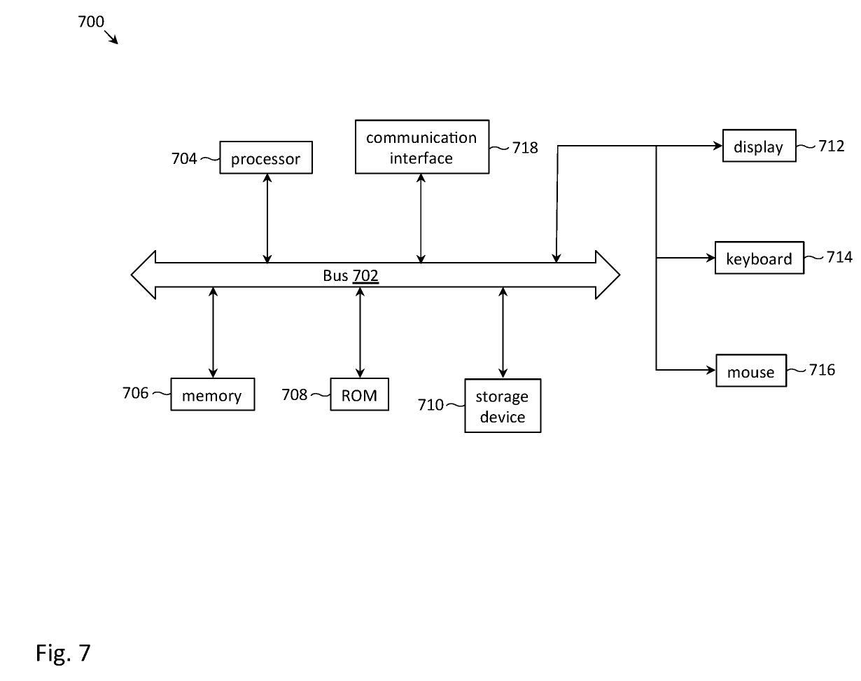

As is apparent from the foregoing discussion, aspects of the present invention involve the use of various computer systems and computer readable storage media having computer-readable instructions stored thereon. FIG. 7 provides an example of computer system 700 that is representative of any of the storage systems discussed herein. Further, computer system 700 is representative of a device that performs the processes depicted in FIGS. 3-6. Note, not all of the various computer systems may have all of the features of computer system 700. For example, certain of the computer systems discussed above may not include a display inasmuch as the display function may be provided by a client computer communicatively coupled to the computer system or a display function may be unnecessary. Such details are not critical to the present invention.

Computer system 700 includes a bus 702 or other communication mechanism for communicating information, and a processor 704 coupled with the bus 702 for processing information. Computer system 700 also includes a main memory 706, such as a random access memory (RAM) or other dynamic storage device, coupled to the bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to the bus 702 for storing static information and instructions for the processor 704. A storage device 710, which may be one or more of a floppy disk, a flexible disk, a hard disk, flash memory-based storage medium, magnetic tape or other magnetic storage medium, a compact disk (CD)-ROM, a digital versatile disk (DVD)-ROM, or other optical storage medium, or any other storage medium from which processor 704 can read, is provided and coupled to the bus 702 for storing information and instructions (e.g., operating systems, applications programs and the like).

Computer system 700 may be coupled via the bus 702 to a display 712, such as a flat panel display, for displaying information to a computer user. An input device 714, such as a keyboard including alphanumeric and other keys, is coupled to the bus 702 for communicating information and command selections to the processor 704. Another type of user input device is cursor control device 716, such as a mouse, a trackball, or cursor direction keys for communicating direction information and command selections to processor 704 and for controlling cursor movement on the display 712. Other user interface devices, such as microphones, speakers, etc. are not shown in detail but may be involved with the receipt of user input and/or presentation of output.

The processes referred to herein may be implemented by processor 704 executing appropriate sequences of computer-readable instructions contained in main memory 706. Such instructions may be read into main memory 706 from another computer-readable medium, such as storage device 710, and execution of the sequences of instructions contained in the main memory 706 causes the processor 704 to perform the associated actions. In alternative embodiments, hard-wired circuitry or firmware-controlled processing units (e.g., field programmable gate arrays) may be used in place of or in combination with processor 704 and its associated computer software instructions to implement the invention. The computer-readable instructions may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying” or the like, refer to the action and processes of an appropriately programmed computer system, such as computer system 700 or similar electronic computing device, that manipulates and transforms data represented as physical (electronic) quantities within its registers and memories into other data similarly represented as physical quantities within its memories or registers or other such information storage, transmission or display devices.

Computer system 700 also includes a communication interface 718 coupled to the bus 702. Communication interface 718 provides a two-way data communication channel with a computer network, which provides connectivity to and among the various computer systems discussed above. For example, communication interface 718 may be a local area network (LAN) card to provide a data communication connection to a compatible LAN, which itself is communicatively coupled to the Internet through one or more Internet service provider networks. The precise details of such communication paths are not critical to the present invention. What is important is that computer system 700 can send and receive messages and data through the communication interface 718 and in that way communicate with hosts accessible via the Internet.

Thus, methods and systems for interfacing a host device with a plurality of SSDs via a plurality of mid-level controllers have been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system, comprising:
a first controller, the first controller communicatively coupled to a first group of solid state drives (SSDs) and a host device, wherein the first controller is configured to perform one or more flash management tasks for one or more SSDs within the first group of SSDs; and
a second controller, the second controller communicatively coupled to a second group of SSDs and the host device, wherein the second controller is configured to perform one or more flash management tasks for one or more SSDs within the second group of SSDs.

2. The system of claim 1, wherein the first and second controllers are not part of the host device, and wherein the first and second controllers are not part of any of the SSDs in the first group or the second group.

3. The system of claim 1, wherein the first group of SSDs is disjoint from the second group of SSDs.

4. The system of claim 1, wherein the first controller is not directly communicatively coupled to the second group of SSDs.

5. The system of claim 1, wherein the second controller is not directly communicatively coupled to the first group of SSDs.

6. The system of claim 1, wherein each of the SSDs from the first group of SSDs comprises an SSD controller and one or more flash modules.

7. The system of claim 6, wherein the first controller is communicatively coupled to the SSD controller of each of the SSDs from the first group of SSDs.

8. A method, comprising:
determining, by a host device, a first flash management task to be performed for one or more solid state drives (SSDs) within a first group of SSDs, and a second flash management task to be performed for one or more SSDs within a second group of SSDs;
determining, by the host device, a first controller communicatively coupled to the first group of SSD, and a second controller communicatively coupled to the second group of SSDs; and
transmitting, by the host device, a first command to the first controller so as to perform the first flash management task for one or more of the SSDs within the first group of SSDs, and a second command to the second controller so as to perform the second flash management task for one or more of the SSDs within the second group of SSDs.

9. The method of claim 8, wherein the one or more flash management tasks include deduplication, redundant array of independent disks (RAID) processing, scrubbing, compression, garbage collection, encryption, bad block management, and wear leveling.

10. The method of claim 8, wherein the first group of SSDs is disjoint from the second group of SSDs.

11. The method of claim 8, wherein the first controller is not directly communicatively coupled to the second group of SSDs.

12. The method of claim 8, wherein the second controller is not directly communicatively coupled to the first group of SSDs.

13. The method of claim 8, wherein the first flash management task is identical to the second flash management task.

14. The method of claim 8, wherein the first flash management task is not identical to the second flash management task.

15. A non-transitory machine-readable storage medium for a host device comprising a main memory and a processor communicatively coupled to the main memory, the non-transitory machine-readable storage medium comprising software instructions that, when executed by the processor, cause the host to:
determine a first flash management task to be performed for one or more solid state drives (SSDs) within a first group of SSDs, and a second flash management task to be performed for one or more SSDs within a second group of SSDs;
determine a first controller communicatively coupled to the first group of SSDs, and a second controller communicatively coupled to the second group of SSDs; and
transmit a first command to the first controller so as to perform the first flash management task for one or more of the SSDs within the first group of SSDs, and a second command to the second controller so as to perform the second flash management task for one or more of the SSDs within the second group of SSDs.

16. The non-transitory machine-readable storage medium of claim 15, wherein the one or more flash management tasks include deduplication, redundant array of independent disks (RAID) processing, scrubbing, compression, garbage collection, encryption, bad block management, and wear leveling.

17. The non-transitory machine-readable storage medium of claim 15, wherein the first group of SSDs is disjoint from the second group of SSDs.

18. The non-transitory machine-readable storage medium of claim 15, wherein the first controller is not directly communicatively coupled to the second group of SSDs.

19. The non-transitory machine-readable storage medium of claim 15, wherein the second controller is not directly communicatively coupled to the first group of SSDs.

20. The non-transitory machine-readable storage medium of claim 15, wherein the first flash management task is not identical to the second flash management task.
